(19) United States
(12) Patent Application Publication
(10) Pub. No.: US 2011/0203858 A1
(43) Pub. Date: Aug. 25, 2011

(54) LAND VEHICLE PROVIDED WITH AN INTERNAL AIR FLOW PROPULSION SYSTEM

(75) Inventor: Jean-Luc Chanel, Blagnac (FR)

(73) Assignee: AIRBUS OPERATIONS (S.A.S.), TOULOUSE (FR)

(21) Appl. No.: 13/056,984

(22) PCT Filed: Aug. 3, 2009
(86) PCT No.: PCT/FR09/51547

§ 371 Date: May 9, 2011

(30) Foreign Application Priority Data
Aug. 4, 2008 (FR) 0855384

(51) Int. Cl. B60K 16/00; B60K 6/20

(52) U.S. Cl. 180/2.1; 180/65.21

(57) ABSTRACT

A land vehicle including an internal air flow propulsion system, a body, and a cabin, and having a plane situated substantially in the center of the vehicle and perpendicular to a longitudinal axis of the vehicle and separating the body into front and rear parts with respect to the vehicle travel direction. The propulsion system includes: an air intake situated on surfaces of the body front part; the air intakes connected to at least one propulsion unit by at least one air suction circuit so as to suck in air that flows at walls; the propulsion unit being connected to at least one air ejection orifice by at least one ejection circuit, the sucked-in air being accelerated and ejected by the propulsion unit towards the outside via the at least one ejection orifice to generate a propulsion force to move the vehicle. The air intakes are defined and distributed on the surfaces of the front part of the chassis to suck in air by the Coanda effect.

The present invention relates to a land vehicle equipped with an internal air flow propulsion system.

There are known land vehicles moved by a propulsive group composed of an internal combustion engine and an airscrew. The operating principle of such a propulsion system is based on the use of sucked-in air to propel the vehicle.

Document FR500436 describes a propulsive system based on the use of the external air flow, wherein the propulsive group is composed of an engine and of an external airscrew. The vehicles equipped with such a system had the appearance of a wingless airplane. Compared with conventional vehicles, these vehicles with air flow propulsion comprise the following technical advantages: simplicity and light weight of the kinematic train, propulsion efficiency, simplicity of driving because of the simplicity of the kinematic train, which is provided no longer with a gearbox and clutch but only with an accelerator and brake control. In addition, another technical advantage conferred by such a land vehicle propelled by air flow is the mobility and stability of the vehicle, resulting from the absence of forces on the wheels, thus making the advance of the vehicle independent of the state of adherence of the wheels to the ground.

Nevertheless, the external airscrew of the propulsive group constitutes an element which is relatively bulky, noisy, not very esthetic and above all a danger for the other users. In addition, such a propulsive system generates very low efficiency at low speed and on inclines, making the vehicle very poorly adapted to city and mountain driving.

Recent studies have been conducted in order that the external air flow via external airscrew might be replaced by an air flow inside the vehicle. Document FR 2432422 presents a vehicle provided with a single airscrew positioned at the front of the vehicle for sucking in external air and a compressor for the sucked-in air, as well as two air conduits to expel the compressed air. Such a configuration is a compromise between the old solution of an external airscrew facing the road, such as described in document FR 500436, and the solution of an internal flow in two air conduits carrying the propulsive flow toward the outside. Nevertheless, this propulsive system does not make it easy to integrate the airscrew in the vehicle body. For this reason, it is not very well adapted from the viewpoint of bulk, safety and esthetics. Furthermore, the configuration of the propulsive system proposed in that document is not optimal in terms of use of the sucked-in air, in fact, the propulsion is not direct, the airscrew stream is not discharged directly into the two pipes adjacent to the cylinder, entailing the risk of loss of head or of an air compression phenomenon.

A problem that then arises and that the present invention intends to overcome is to furnish a land vehicle equipped with an internal air flow propulsion system, which not only makes it possible, by virtue of its performance, to propel the vehicle exclusively by the forces generated by the air flow, but which also does not simultaneously generate any problem of safety, any problem of esthetics, external bulk and noise.

To achieve this objective, the present invention proposes a land vehicle equipped with an internal air flow propulsion system, the said vehicle comprising a body and a cab, the said vehicle having a plane situated substantially in the middle of the said vehicle and perpendicular to a longitudinal axis of the vehicle, separating the body into a front part and a rear part relative to the direction of movement of the vehicle (F), characterized in that the said propulsion system comprises:
air intakes situated on the surfaces of the front part of the body;
the said air intakes being in communication with at least one propulsive group via at least one air suction circuit so as to suck in the air flowing along the walls;
the said at least one propulsive group being in communication with at least one air ejection orifice via at least one ejection circuit, the sucked-in air being accelerated and ejected by means of the said at least one propulsive group toward the outside via the said at least one ejection orifice so as to generate a propulsive force to move the vehicle.

According to one embodiment, the said at least one ejection orifice is composed of a set of slots made on the end surfaces of the rear part or in proximity to the end of the rear part of the body.

By surfaces in proximity to the end of the rear part, there are understood the surfaces of side panels, of the floor and of the roof of the rear part of the body.

According to one embodiment, the end of the rear part is additionally provided with a substantially vertical portion forming an end cap of the vehicle, the said at least one ejection orifice being formed by a horizontal slot made on the surface of the said end cap.

According to one embodiment of the invention, the body is provided with an aerodynamic shape, so as to generate a substantially laminar air flow.

According to one embodiment, the said at least one propulsive group is composed of an engine coupled with air compressor means.

In general, the engine is an internal combustion heat engine, but it may be an electrical or pneumatic motor. The air compressor means may be a streamlined airscrew, a fan or any type of compressor.

According to one embodiment, the vehicle is additionally provided with at least one mobile aerodynamic flap made on the rear part of the body and with one control means capable of displacing the said flap between a rest position in which the flap is closed and an active position in which the flap is open.

According to one embodiment, the vehicle is provided with two flaps disposed symmetrically on both sides of the longitudinal axis of the vehicle.

According to one embodiment, the vehicle is equipped with two control devices capable of actuating the two flaps in dissymmetric manner or simultaneously.

According to one embodiment, the land vehicle is additionally provided with an electric drive system to drive the wheel trains, the said internal air flow propulsion system and the said electric drive system being connected to a control system making it possible to selectively activate the electric drive system or the internal air flow propulsion system or both together, so that the motor vehicle is able to operate respectively in electric drive mode, in internal air flow propulsion mode or in hybrid mode.

By hybrid mode there is understood a mode of operation combining the electric drive mode and the internal air flow propulsion mode.

The objective of the electric drive system is to perform the following tasks: forward and reverse travel at low speed, acceleration up to the speed threshold at which the internal air flow propulsion system can operate in optimum manner, driving in the city and on steep inclines. The speed range is therefore covered by the two independent modes of operation, although they may be combined together.

For this reason, it is possible to adapt the propulsive group, or in other words the engine and the air-compressor means, to operate in a single range corresponding to the maximum efficiency.

The invention will be better understood by reading the description hereinafter and examining the accompanying figures. These figures are provided merely by way of illustration but are in no way limitative of the invention. They show:

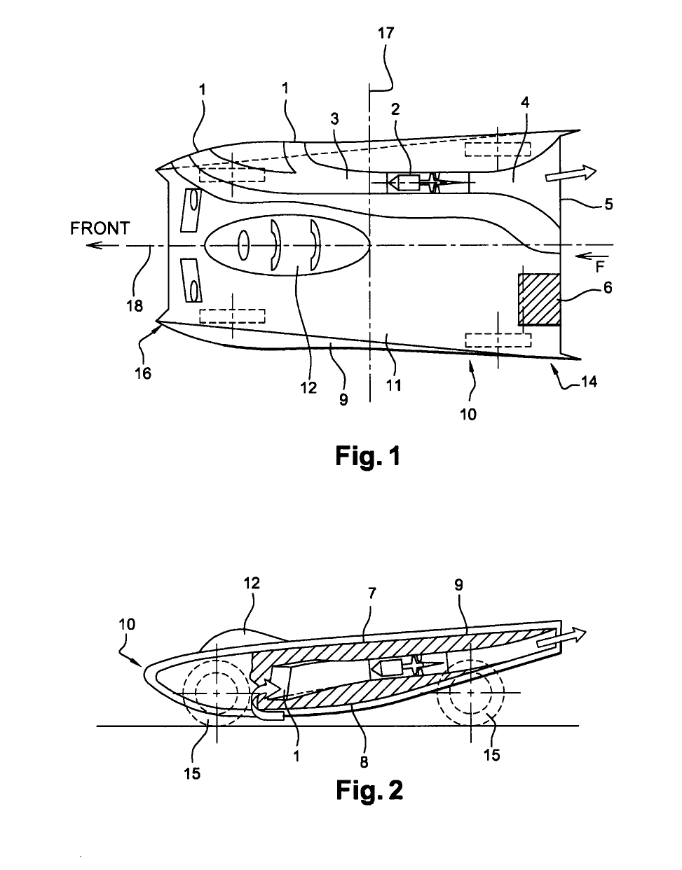

FIG. 1: a schematic overhead view of a land vehicle according to the invention, partially revealing the vehicle interior, showing the installation of an internal air flow propulsion system;

FIG. 2: a schematic view in longitudinal section of a vehicle according to the invention;

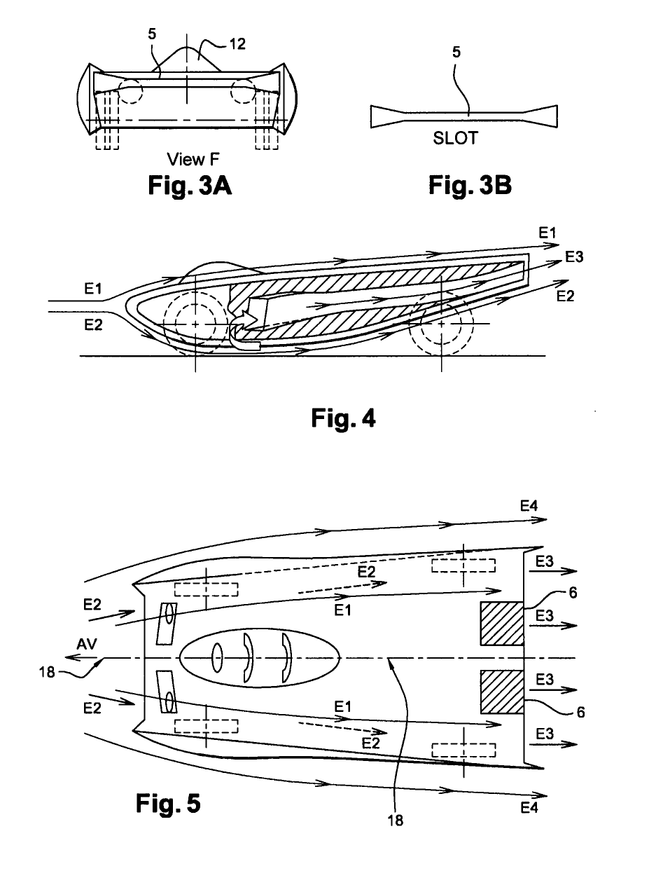

FIGS. 3A and 3B: a schematic front view of the rear part forming the end cap of a vehicle and a schematic illustration of the air-ejection slot;

FIGS. 4 and 5: schematic representations of the air flows around the vehicle;

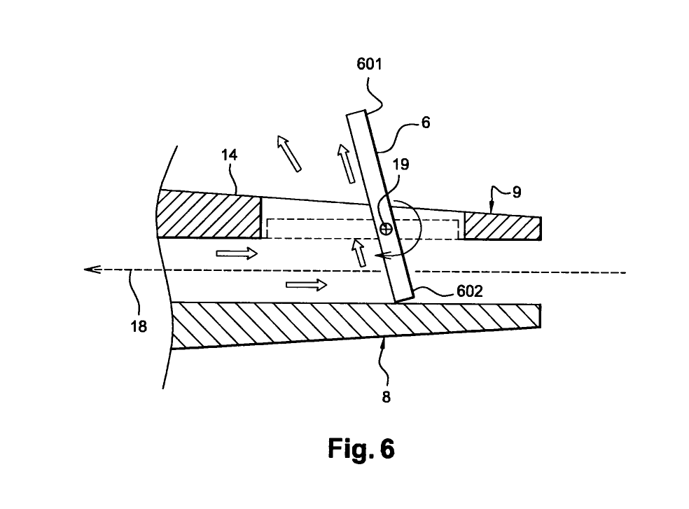

FIG. 6: a schematic profile view in section of a flap displaced from a closed position to an open position.

FIG. 1 and FIG. 2 show a land vehicle 10 according to the invention according to an overhead view and a profile view respectively.

Vehicle 10 has a body 11 defining a wall enclosing a cab 12, in which a driver's space is installed. Vehicle 10 has a plane 17 situated substantially at the middle of the vehicle and perpendicular to a longitudinal axis 18 of the vehicle, this plane making it possible to define a front part 16 and a rear part 14 of the vehicle body.

In general, body 11 has a substantially horizontal portion bounding roof 7 of the vehicle, another substantially horizontal portion bounding floor 8 of the vehicle and side panels 9 (FIG. 2). In the rear part of the vehicle, the portions are joined to one another by a vertical portion forming the end cap of the vehicle.

The shape of the body is given here by way of indication. Preferably it has an aerodynamic shape, comparable to an inverted wing, composed of developable surfaces.

Thus, taking this body geometry into account, when the vehicle is moving forward in the direction F, the air flowing along the walls of the different portions of the vehicle forms a laminar frontal aerodynamic air flow (E1+E2; see FIG. 4 and FIG. 5). For this reason, this form of air flow along the walls of body 11 makes it possible to avoid separation, which is responsible for the aerodynamic drag of the vehicle and consequently its dynamic stability and its penetration in the air.

Preferably side panels 9 are composed of plane or cambered plate, on which there is fixed a convex plate having an aerodynamic function.

In order to create a propulsive force for moving the vehicle in the direction of F, front part 16 of the body has air intakes 1 situated on the outside wall. These air intakes are in communication with one or more propulsive groups 2 via an air suction circuit 3. Thus an air mass taken in by means of air intakes 1, judiciously distributed over the wall of the body, follows air suction conduits 3 under the Coanda effect due to the action of the propulsive group. These air intakes generate low-pressure zones in the front part of the body.

Propulsive group 2 such as illustrated in FIG. 1 is housed in a fairing installed inside the body. Via an ejection circuit 4, this propulsive group is also in communication with air ejection orifices 5 situated in rear part 14 of the body. Thus the absorbed air passes through the engine and is discharged at high velocity by the propulsive group via ejection orifices 5 toward the rear so as to generate a propulsive force for moving vehicle 10.

The propulsive group is preferably installed inside the vehicle, at the middle thereof, thus making it possible to eliminate any problem of risk of interference with elements situated outside the vehicle, also eliminating the problem of bulk and esthetics.

Advantageously, the zones of low air pressure generated by admission of air into the propulsive group and the zones of high air pressure generated by the ejection of air from the propulsive group are positioned on the body so that they improve the air penetration coefficient. For this reason, all of the forces generated by the zones of high and low air pressure participate in the propulsion of the vehicle.

The vehicle may be provided with one or a plurality of propulsive groups.

These propulsive groups on board the same land vehicle operate independently of one another, thus making it possible to regulate the propulsion power according to the need for use thereof.

In addition, the fact that a plurality of propulsive groups is available makes it possible to use groups of smaller size, permitting a simpler installation. In case of failure, the propulsion system is more reliable than with a single propulsive group. One or more propulsive groups may be removed from the vehicle for maintenance or repair without immobilizing the vehicle, which is able to travel with temporarily reduced power.

Propulsive group 2 is mounted removably in the vehicle. Its mounting in the vehicle as well as its removal can be achieved advantageously by one person without tools. It is mounted on two rails, coming to a stop against one end of the rail, a hand-tightened nut at the opposite end of the rail preventing its return movement. It is then connected manually to an inlet of the energy source for its operation as well as to a power control.

FIG. 1 shows a preferred embodiment of the invention in which rear part 14 is additionally provided with a substantially vertical portion forming an end cap of the vehicle. Ejection orifices 5 are then formed by a horizontal slot made over the entire width of the vehicle, its ejection cross section being equal to the surface of the vertical portion.

FIG. 3A shows a front view of the rear part of the body forming an end cap, on which the horizontal slot is made, and FIG. 3B shows the horizontal slot on its own for more clarity.

FIGS. 4 and 5 illustrate the air flows around the body.

Advantageously, by virtue of the Coanda effect, the propulsion flow (E3) in the end cap zone makes it possible to reduce the aerodynamic drag induced by the upper surface of the vehicle, and to eliminate separation of the air flow over these horizontal surfaces, such as roof 7 (E1) and floor 8 (E2), and over the vertical surfaces of side panels 9 (E4). The resultant air flow (E1+E2+E3+E4) therefore remains laminar, participating in the propulsion force.

A vortex flow exists in the rear and side part of the vehicle when the high-pressure (E1) and low-pressure (E4) air flows encounter one another and become mixed. It is possible to envision a shape of side panels 9 combined with a trapezoidal shape of the slot in the vicinity of the panels in order to eliminate this vortex drag, because the flows (E1) and (E4) in these zones are in the same direction and move at substantially the same velocity.

According to a variant of the invention, not illustrated, in which the vehicle body is not provided with an end cap surface, ejection orifices 5 are composed of a set of slots, made in the surfaces of side panels 9, of floor 8 and of roof 7 of rear part 14 of the body. The slot is then provided with an opening shape chosen so as to derive maximum benefit from the Coanda effect on the air flows of the adjacent surfaces.

According to another variant, the slots made in the surfaces of roof 7, floor 8 and side panels 9 can be added in the preferred embodiment of the invention, in which the end cap is equipped with a horizontal slot 5.

According to a particularly advantageous embodiment, the vehicle is provided with aerodynamic flaps 6 made in rear part 14 of the vehicle body. These flaps have the function of inverting the air stream at the outlet of the propulsive group, making it deviate toward the front of the vehicle, thus generating an aerodynamic drag and therefore a braking force known as “counter thrust”, which contributes to deceleration of the vehicle.

FIG. 5 shows an embodiment of the invention in which the vehicle is provided with two flaps 6 disposed symmetrically on both sides of longitudinal axis 18.

FIG. 6 shows the operating principle of such a flap in more detail, the flap being made in the thickness of the body. In rest position, the flap is closed, meaning that it extends in a prolongation of the body wall. In active position, it is open, meaning that one flap part 601 extends toward the outside of the body and another flap part 602 extends toward the inside of the body, in a direction substantially perpendicular to longitudinal axis 18 of the vehicle. Thus, when the flap is open, part 602 extending toward the inside shuts off the air stream at the outlet of the propulsive group. The air stream is then blocked, and is evacuated out of the body by an orifice uncovered when the flap is opened. Flap part 601 extending toward the outside makes it possible to direct the air stream toward the front of the vehicle. This deflection of the air stream is illustrated by arrows in FIG. 6.

By aerodynamic flap there is understood a flap whose outside wall has a shape such that, when it is closed, its outside wall forms an aerodynamic continuity with the adjacent walls of the body.

To achieve this displacement between the inactive position and the active position, the flap is mounted to pivot on the body, the pivot shaft 19 being situated substantially in the middle of flap 6.

The vehicle is additionally provided with a control device (not illustrated in FIG. 6) associated with each flap, such as a jack making it possible to actuate the opening and closing of the flap. These devices make it possible to actuate the two flaps simultaneously during a braking phase in order to brake the vehicle.

Advantageously, these devices are also capable of actuating the two flaps in dissymmetric manner, thus making it possible to introduce a turning couple and to contribute to the cornering ability of the vehicle. To achieve cornering, the vehicle is also equipped with a steering wheel that acts directly on the guiding wheels. It is possible to envision introducing a turning couple by two non-aligned propulsive groups, thus making it possible to contribute to the cornering ability of the vehicle. These three actions may be employed in parallel or separately at the demand of the driver, thus making it possible to control the stability of the vehicle according to the road condition.

So as to cover all speed ranges, the land vehicle is also equipped with an electric drive system for wheels 15 as a complement to the internal air flow propulsion system. These two systems are connected together to a control system disposed, for example, in the driver's space, permitting the driver to activate, selectively, the electric drive system or the propulsion system or both simultaneously, so that the vehicle can operate respectively in electric drive mode, in internal air flow propulsion mode or in hybrid mode, depending on the need for its use.

Hereinafter an example of operation of the hybrid drive group according to the invention now is described in detail for different phases of travel of the vehicle.

In the phase of starting on a flat surface or on an incline, the driver activates the electric drive system, which continues to operate until the vehicle attains a threshold speed at which the propulsive group or groups can operate in the maximum efficiency range.

In the phase of travel at high speed, the driver deactivates the electric drive system and allows the internal air flow propulsion system to operate.

In the braking phase, the driver activates flaps 6 to move them to thrust inversion position in order to initiate deceleration of the vehicle, and the electric motor is switched to generator mode operation in order to brake the vehicle.

As in the case of conventional hybrid vehicles, the electric motor is connected to an energy storage system such as batteries, in order to store the recovered energy of electrical braking.

The land vehicle according to the invention permits simpler and less costly industrial manufacture as compared with a conventional vehicle, because of the absence of a gearbox and clutch and also by virtue of a small number of separate pieces compared with a conventional vehicle.

1-10. (canceled)

11. A land vehicle comprising:
an internal air flow propulsion system;
a body;
a cab;
the vehicle having a plane situated substantially in a middle of the vehicle and perpendicular to a longitudinal axis of the vehicle, separating the body into a front part and a rear part relative to a direction of movement of the vehicle, and
wherein the propulsion system comprises:
air intakes defined and distributed on surfaces of the front part of the body so as to suck in air under the Coanda effect;
the air intakes being in communication with at least one propulsive group via at least one air suction circuit so as to suck in the air flowing along walls;
the at least one propulsive group being in communication with at least one air ejection orifice via at least one ejection circuit, the sucked-in air being accelerated and ejected by the at least one propulsive group toward the outside via the at least one ejection orifice so as to generate a propulsive force to move the vehicle.

12. A land vehicle according to claim 11, wherein the at least one ejection orifice includes a set of slots on end surfaces of the rear part or in proximity to an end of the rear part of the body.

13. A land vehicle according to claim 12, wherein the end of the rear part additionally includes a substantially vertical portion forming an end cap of the vehicle, the at least one ejection orifice being formed by a horizontal slot made on a surface of the end cap.

14. A land vehicle according to claim 11, wherein the body has an aerodynamic shape, so as to generate a substantially laminar air flow.

15. A land vehicle according to claim 11, wherein the at least one propulsive group includes an engine coupled with compressor means.

16. A land vehicle according to claim 11, wherein the at least one propulsive group is mounted removably in the vehicle.

17. A land vehicle according to claim 11, further comprising at least one mobile aerodynamic flap made in the rear part of the body and control devices configured to displace the at least one flap between a rest position in which the flap is closed and an active position in which the flap is open.

18. A land vehicle according to claim 17, including two flaps, the two flaps being disposed on both sides of the longitudinal axis of the vehicle.

19. A land vehicle according to claim 18, including two control devices, the control devices configured to actuate the two flaps in a dissymmetric or simultaneous manner.

20. A land vehicle according to claim 11, further comprising an electric drive system to drive wheel trains, the internal air flow propulsion system and the electric drive system being connected to a control system configured to selectively activate the electric drive system or the internal air flow propulsion system or both together, so that the motor vehicle is configured to operate respectively in an electric drive mode, in an internal air flow propulsion mode, or in a hybrid mode.
